(19) United States
(12) Patent Application Publication
(10) Pub. No.: US 2025/0310755 A1
(43) Pub. Date: Oct. 2, 2025

(54) METHODS AND SYSTEMS FOR SHARING A PLURALITY OF SIM CARDS

(71) Applicant: Pismo Labs Technology Limited, Kowloon (HK)

(72) Inventors: Alex Wing Hong CHAN, Kowloon (HK); Yu YEUNG, Kowloon (HK); Man Kit KWAN, Kowloon (HK); Uzair Ahmed CHUGHTAI, Kowloon (HK); Ka Ho HO, Kowloon (HK)

(73) Assignee: Pismo Labs Technology Limited, Kowloon (HK)

(21) Appl. No.: 18/862,167

(22) PCT Filed: Aug. 22, 2022
(86) PCT No.: PCT/IB2022/057839

§ 371 Date: Oct. 31, 2024

(51) Int. Cl. H04W 8/20; H04W 8/18

(52) U.S. Cl. CPC H04W 8/205; H04W 8/186

(57) ABSTRACT

Methods and systems for using a universal integrated circuit card (UICC) of a second network device at first network device for communication. The first network device may be managed through the second network device. The first network device sends a UICC selection request to a UICC selection module. When a UICC selection reply is received, the first network device sends a UICC information request to the second network device to receive a UICC information. The first network device then establishes a wireless communication channel with the UICC information through its first wireless communication module. At least two processing units of the second network device may communicate with each other by using Internet Protocol (IP) packets through at least two internal network interfaces.

### TECHNICAL FIELD

The present invention relates to wireless communication devices that use SIM cards to establish wireless connections via wireless carrier networks, and more particularly to use a plurality of SIM cards from a plurality of wireless communication devices and establish the wireless connections through a plurality of wireless communication modules from the plurality of wireless communication devices.

### BACKGROUND

With the proliferation of cellular wireless data communication, it is common for network administrators to deploy wireless communication devices (WCDs) as wireless routers using 3G/4G/LTE/5G technologies for offices, IoT devices, schools, and different types of organizations. When there are a large number of WCDs deployed, management of WCDs, and Subscriber Identity Modules (SIM) cards may become a daunting task, especially when the WCDs are located at remote offices or hard to reach places.

U.S. Pat. Nos. 11,277,736 and 9,854,435 disclosed methods and systems for a WCD to use remote SIM cards (R-SIMs) from one or more SIM banks. U.S. Pat. No. 10,412,658 disclosed methods and systems for a WCD to use one or more other WCDs through one or more wide area network (WAN) network interfaces.

However, in certain network environments or usage scenarios, it may not be desirable to use R-SIMs when there is a plurality of SIM cards available at a plurality of WCDs, which are located at the same premises. It is known that R-SIMs may not be reliable as SIM information sent and received through the interconnected networks may be subject to delay and data loss. Further, a network administrator may not want to invest in a SIM bank upfront for each premises. It is also time consuming when the network administrator has to configure and manage each WCD.

### SUMMARY OF THE INVENTION

The present invention discloses methods and systems of using SIM cards from a second network device at a first network device. The processes comprise: the second network device sending a SIM card selection request to a SIM card selection module. Then the SIM card selection module replies to the second network device with the information of the selected SIM card. When the second network device received the selected SIM card information from the SIM card selection module, the second network device requests the first network device with the selected SIM card information. After that, the first network device replies to the second network device with the selected SIM card authentication information. Finally, the second network device completes the authentication process with the SIM card module to establish a communication channel and to use the selected SIM card.

The first and second network devices of the present invention may be connected physically through a cable or wirelessly through a plurality of wireless communication modules. The first and second network devices may be housed in the same premises or located in different premises.

In one example, a network administrator may configure and manage the second network device to use wireless communication modules of the first network device and the second network device to establish wireless communication channels with wireless networks. An aggregated end-to-end connection may also be established through wireless communication channels.

The user interface of the present invention allows the network administrator or a user to select a SIM card from a plurality of SIM profiles and use the selected SIM card.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram of a network connections;

FIG. 2 is a schematic diagram of a network connections;

FIG. 3A is a schematic block diagram of a network device (cited from prior art);

FIG. 3B is a schematic block diagram of a network device (cited from prior art);

FIG. 3C is a schematic block diagram of a network device;

FIG. 3D is a schematic block diagram of a network device of the present invention;

FIG. 3E is a schematic block diagram illustrates the connection between the WCD and the SIM module;

FIG. 4A is an event diagram illustrating a flow of SIM card selection and data flow;

FIG. 4B is a flow diagram illustrating the SIM selection module flow;

FIG. 5 is an event diagram illustrating a flow of SIM card selection and data flow;

FIG. 6 is a schematic diagram of a network connections;

FIG. 7 is a schematic block diagram illustrating the Ethernet encapsulation;

FIG. 8A is a schematic diagram of a network connections comprises slave gateways (cited from prior art);

FIG. 8B is a schematic diagram of a network connections comprises slave gateway (cited from prior art);

FIG. 9 is an event diagram of an event sequence; and

FIGS. 10A and 10B is a schematic block diagram illustrating a user interface.

### Network Architecture

The ensuing description provides preferred exemplary embodiment(s) only and is not intended to limit the scope, applicability, or configuration of the invention. Rather, the ensuing description of the preferred exemplary embodiment(s) will provide those skilled in the art with an enabling description for implementing a preferred exemplary embodiment of the invention. It is being understood that various changes may be made in the function and arrangement of elements without departing from the spirit and scope of the invention as set forth in the appended claims.

Specific details are given in the following description to provide a thorough understanding of the embodiments. However, it will be understood by one of the ordinary skills in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process that is depicted as a flowchart, a flow diagram, a data flow diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Although the methods and apparatuses have been described in accordance with the embodiments shown, one with ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

Embodiments, or portions thereof, may be embodied in program instructions operable upon a processing unit for performing functions and operations as described herein. The program instructions making up the various embodiments may be stored in a storage medium. Moreover, as disclosed herein, the term “storage medium” may represent one or more devices for storing data, including read-only memory (ROM), programmable ROM (PROM), erasable PROM (EPROM), random access memory (RAM), magnetic RAM, core memory, floppy disk, flexible disk, hard disk, magnetic tape, compact disc ROM (CD-ROM), flash memory device, a memory card and/or other machine-readable medium for storing information.

The term “machine-readable medium” includes, but is not limited to portable or fixed storage devices, optical storage devices, wireless channels, and various other mediums capable of storing, containing, or carrying instruction(s) and/or data. A machine-readable medium can be realized by virtualization and can be a virtual machine-readable medium including a virtual machine-readable medium in a cloud-based instance. Furthermore, embodiments may be implemented by hardware, software, firmware, middleware, microcode, hardware description, languages, or any combination thereof. When implemented in software, firmware, middleware, or microcode, the program code or code segments to perform the necessary tasks may be stored in a machine-readable medium such as a storage medium.

The term computer-readable medium, main memory, secondary storage, or other storage media as used herein refers to any medium that participates in providing instructions to a processing unit for execution. The processing unit reads the data written in the primary storage medium and writes the data in the secondary storage medium. Therefore, even if the data written in the primary storage medium is lost due to a momentary power failure and the like, the data can be restored by transferring the data held in the secondary storage medium to the primary storage medium. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks. Volatile storage includes dynamic memory. Transmission media includes coaxial cables, copper wire, and fibre optics. Transmission media can also take the form of acoustic or light waves, such as those generated during radio-wave and infrared data communications.

A volatile storage may be used for storing temporary variables or other intermediate information during the execution of instructions by a processing unit. A non-volatile storage or static storage may be used for storing static information and instructions for the processor, as well as various system configuration parameters.

The storage medium may include a number of software modules that may be implemented as software codes to be executed by the processing unit using any suitable computer instruction type. The software code may be stored as a series of instructions or commands, or as a program in the storage medium.

Various forms of computer-readable media may be involved in carrying one or more sequences of one or more instructions to the processor for execution. For example, the instructions may initially be carried on a magnetic disk from a remote computer. Alternatively, a remote computer can load the instructions into its dynamic memory and send the instructions to the system that runs one or more sequences of one or more instructions.

A processing unit may be a microprocessor, a microcontroller unit (MCU), a digital signal processor (DSP), a complex programmable logic device (CPLD), a field-programmable gate array (FPGA), a central processing unit (CPU), any combination of those devices, or any other circuitry configured to process information.

A processing unit executes program instructions or code segments for implementing embodiments of the present invention. Furthermore, embodiments may be implemented by hardware, software, firmware, middleware, microcode, hardware description languages, or any combination thereof. When implemented in software, firmware, middleware, or microcode, the program instructions to perform the necessary tasks may be stored in a computer-readable storage medium. A processing unit(s) can be realized by virtualization and can be a virtual processing unit(s) including a virtual processing unit in a cloud-based instance.

Embodiments of the present invention are related to the use of a computer system for implementing the techniques described herein. In an embodiment, the inventive processing units may reside on a machine such as a computer platform. According to one embodiment of the invention, the techniques described herein are performed by the computer system in response to the processing unit executing one or more sequences of one or more instructions contained in the volatile memory. Such instructions may be read into the volatile memory from another computer-readable medium. Execution of the sequences of instructions contained in the volatile memory causes the processing unit to perform the process steps described herein. In alternative embodiments, hard-wired circuitry may be used in place of or in combination with software instructions to implement the invention. Thus, embodiments of the invention are not limited to any specific combination of hardware circuitry and software.

Alternatively, hardware circuitry may be used in place of, or in combination with, software instructions to implement processes consistent with the principles of the invention. Thus, implementations consistent with the principles of the invention are not limited to any specific combination of hardware circuitry and software.

A network interface may be implemented by a standalone electronic component or may be integrated with other electronic components. A network interface may have no network connection or at least one network connection depending on the configuration. A network interface may be an Ethernet interface, a frame relay interface, a fibre optic interface, a cable interface, a Digital Subscriber Line (DSL) interface, a token ring interface, a serial bus interface, a universal serial bus (USB) interface, Firewire interface, Peripheral Component Interconnect (PCI) interface, cellular network interface, etc.

A network interface may connect to a wired or wireless access network. An access network may carry one or more network protocol data. A wired access network may be implemented using Ethernet, fibre optic, cable, DSL, frame relay, token ring, serial bus, USB, Firewire, PCI, or any material that can pass information. A wireless access network may be implemented using infrared, High-Speed Packet Access (HSPA), HSPA+, Long Term Evolution (LTE), Worldwide Interoperability for Microwave Access (WiMAX), General packet radio service (GPRS), Global System for Mobile Communications (GSM), Enhanced Data rates for GSM Evolution (EDGE), Code Division Multiple Access (CDMA), wireless fidelity (Wi-Fi), Code Division Multiple Access 2000 (CDMA-2000), Wideband CDMA (WCDMA), Time Division CDMA (TD-SCDMA), BLUETOOTH, wireless broadband (WiBro), Evolution-Data Optimized (EV-DO); Digital Enhanced Cordless Telecommunications (DECT); Digital AMPS (IS-136/TDMA); Integrated Digital Enhanced (iDEN) or any other wireless technologies. For example, a network interface may be used as a local area network (LAN) interface or a wide area network (WAN) interface.

As disclosed herein the term “wireless communication module” (WCM) may represent a transceiver module to provide network capabilities to a power controller or power controller server using 3G, GPRS, or global positioning system (GPS) modules, through wires or an Ethernet cable. The wireless communication module lowers a processing unit to obtain user information and the communications port of the wireless communication module can connect to a personal computer or other power controller or power controller server (PCS) through wires or wirelessly by using a serial bus or Ethernet or using 2G/3G/4G or LTE technology. The wireless communication module can be used as a network interface for applications that require data to be shared between a power controller and an intelligent device such as a host computer and/or a server.

A system bus may carry signals between a master component (e.g., a processing unit) and peripheral components, or among the peripheral components. A system bus may include a plurality of signal lines connecting the components inside or outside of a device. A system bus disclosed herein may be realized using any of several types of bus structures, including a memory bus, a peripheral bus, or a local bus using any of a variety of bus architecture.

A wireless carrier network, for the purposes of this specification, is a service provider of a wireless carrier network that owns or controls, or both, the wireless carrier network and all necessary elements including backhaul infrastructure, billing, customer care, provisioning computer systems to provide wireless voice and data communication services for its subscribed mobile users. A wireless carrier network is also known as a mobile network operator (MNO), wireless service provider, wireless carrier, cellular company, wireless carrier network service provider, or mobile network carrier.

A wireless carrier network may be implemented using multiple radio access networks connected to a core network. Each regional portion of the wireless carrier network may include a number of base stations, also referred to as network cells. The wireless carrier network may provide telecommunication services in accordance with one or more technical standards, such as Enhanced Data Rates for EDGE, WCDMA, HSPA, LTE, CDMA-2000, and 5th Generation (5G).

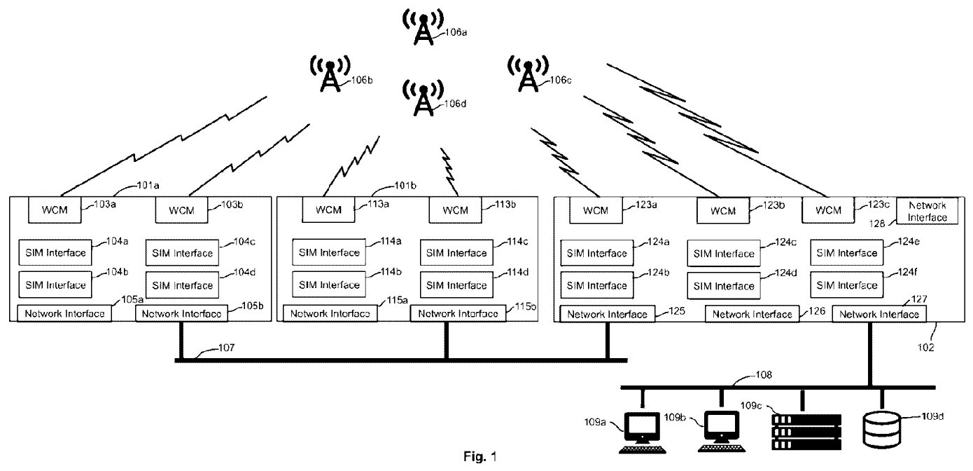

FIG. 1 illustrates a typical network environment according to various embodiments of the present invention. WCDs 101a, 101b, and 102 are connected together via a LAN 107 and communicate with base stations 106a-d using wireless technologies through wireless communication modules (WCMs) 103a-b, 113a-b, and 123a-c respectively. There is no limitation on the number of WCMs that a WCD must have, except that a WCD should have at least one WCM and preferably a plurality of WCMs. Those who are skilled in the art will readily realize that numerous configurations of WCDs 101a, 101b, and 102 and base stations 106 may allow WCDs 101a, 101b, and 102 to connect to private networks, private interconnected networks, public interconnected networks and/or a mixture of private and public interconnected networks. WCMs may be connected to embedded/external antennas and perform wireless communication via the antennas. An example of WCM is Sierra Wireless EM7511. WCM is also known as a wireless modem, wireless module, and cellular module. WCDs 101a, 101b, and 102 may perform functions of routers and/or gateways.

WCDs 101a, 101b, and 102 are located on the same premises. For example, WCDs 101a, 101b, and 102 may be placed by an administrator in the same building. In another example, WCDs 101a, 101b, and 102 may be placed in different compartments of a vessel. In another example, WCDs 101a, 101b, and 102 may be placed close together in a truck. WCDs 101a, 101b, and 102 are preferable to be placed close together within 100 meters or the limitation of an Ethernet cable. This allows the low error and short latency communications among WCDs 101a, 101b, and 102.

SIM interfaces 104a-d, 114a-d, 124a-b are Subscriber Identity Modules (SIM) interfaces. Depending on the manufacturing model of a SIM interface, a SIM interface is capable of connecting to a Universal Integrated Circuit Card (UICC) only or an embedded UICC (eUICC). A UICC is also commonly known as a SIM card. Aspects of eSIM provisioning include the downloading, installing, enabling, disabling, switching, and deleting of an eSIM profile on an eUICC. eUICC is also known as eSIM. Those who are skilled in the art would appreciate that eSIM and eUICC may be used interchangeably eSIM is for hosting eSIM profiles. One eSIM may store a plurality of eSIM profiles.

It is possible that a SIM interface may or may not connect to a SIM card or an eUICC, depending on whether the administrator of the WCD has placed a SIM card in the SIM card holder (not shown), which is connected to the SIM interface. Those who are skilled in the art will readily realize when a SIM card is placed in a SIM card holder or when an eSIM is used, a WCD may use the SIM card or eSIM for information, authentication, and other functionalities. There is no limitation for the present invention that a SIM card must be placed at the SIM card holder in a WCD. For example, among the four SIM interfaces 104a-d, there are no SIM cards in the SIM card holders connecting to SIM interfaces 104a and 104c representatively, and there are SIM cards in the SIM card slot connecting to SIM interfaces 104b and 104d. In another example, SIM interface 114a is connected to an eSIM while SIM interfaces 114b-d have SIM cards placed in the SIM card holders connecting to SIM interfaces 114b-d respectively. There is no limitation on the number of SIM interfaces that a WCD must have according to various embodiments of the present invention unless otherwise specified.

For readability, a SIM card interface and an eSIM interface may be referred to as SIM interface herein unless specified otherwise. A SIM card and eSIM may be referred to as a SIM card herein unless specified otherwise. Those who are skilled in the art will readily realize that it is common to have a SIM profile in a SIM card and it is common to have one or more SIM profiles in an eSIM.

Network interfaces 105a-b, 115a-b, and 125-128 are used to communicate with other network devices and can be realized using Ethernet, Wi-Fi, IEEE 802.11, Bluetooth, infra-red, RS-232, USB, near-field communication (NFC), and other networking technologies. For example, network interface 105a is capable of using IEEE 802.11ax to communicate with other devices while network interface 105b is an Ethernet network interface.

There is no limitation on the types of wireless communication technologies that should be used for a WCM as long as the WCM relies on SIM information for authentication. For example, WCM 103a may use 5G to communicate with one of base stations 160a-d while WCM 123b may use LTE-A to communicate with one of base stations 160a-d.

There is no limitation that WCDs 101a, 101b and 102 must be connected to LAN 107 via a common wire. It is preferable that a LAN, such as LAN 107 and LAN 108, is realized through a network switch, which is not illustrated. WCDs 101a, 101b, and 102 may connect to the network switch via Ethernet cables respectively. WCDs 101a, 101b, and 102 are preferably placed in the same premises or not far from each other. For example, when connecting via a network switch via Cat 5e cables, WCDs 101a, 101b, and 102 should be within 100 meters from the switch. In another example, when connecting via an IEEE 802.11 wireless switch, WCDs 101a, 101b, and 102 should be within the distance to maintain the recommended signal-to-noise-ratio (SNR) of the wireless switch.

Hosts 109a-d are connected to WCD 102 through LAN 108 and network interface 127.

One of the benefits of the present invention is that hosts 109a-d are able to send data to and receive data from base stations 106 through WCD 102, which is able to use the WCMs 103a-b and 113a-b respectively. There is no limitation that all hosts 109a-d must be using the same network interface 127. For example, host 109a-b may connect to WCD 102 through network interface 126 using a LAN different from LAN 108 while hosts 109c-d continue to use LAN 108.

In one example, WCD 102 may form an aggregated end-to-end connection with a server reachable through base stations 106. WCD 102 communicates with WCDs 101a and 101b to make a plurality WCMs of WCMs 103 and WCM 113 available to establish a plurality of end-to-end connections of the aggregated end-to-end connection, WCD 102 may additionally use one or more of WCM 123 to establish additional end-to-end connections of the aggregated end-to-end connection. The WCMs used may be associated with SIM cards or eSIMs housed in WCD 101a, WCD 101b, and WCD 102. The aggregated end-to-end connection may then be used to send and receive data packets between one or more hosts, such as hosts 109, at the LAN of WCD 102 and the server. An end-to-end connection may be realized by many protocols, such as Transmission Control Protocol (TCP), Internet Protocol Security (IPsec), Generic Routing Encapsulation (GRE) and different VPN protocols.

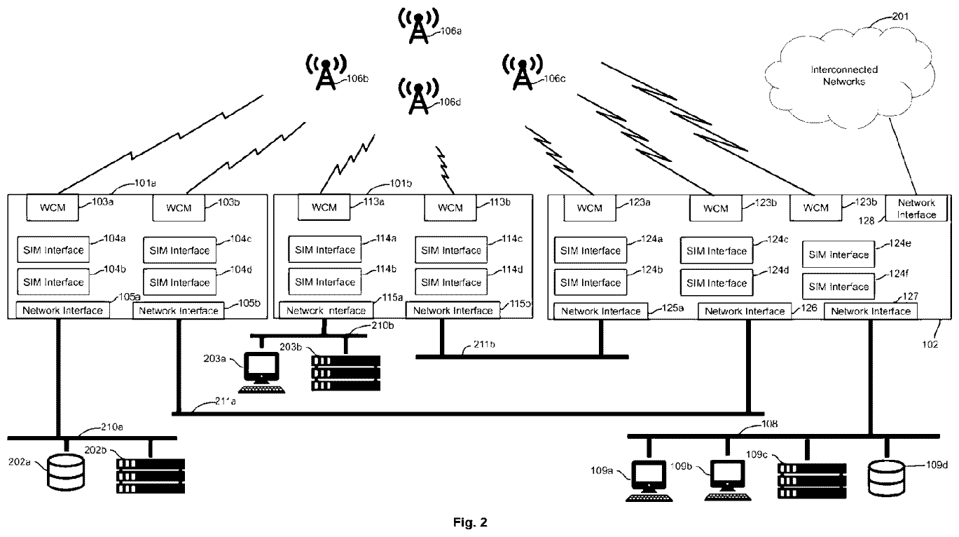

FIG. 2 illustrates a network environment according to various embodiments of the present invention. The network environment illustrated in FIG. 2 is similar to the network environment illustrated in FIG. 1. However, WCD 101a and WCD 101b are connected to WCD 102 through different LANs, which are LAN 211a and LAN 211b respectively. WCD 101a and WCD 101b are also connected to network devices 202a-b and 203a-b through LAN 210a and LAN 210b respectively.

WCD 102 is connected to interconnected networks 201 through network interface 128. Interconnected networks 201 may or may not be capable of connecting to base stations 106. According to various embodiments of the present invention, one of the benefits of the present invention is that data packets to and from network devices 202a-b may be received and transmitted through WCDs 101a and 102; and data packets to and from network devices 203a-b may be received and transmitted through WCD 101b and 102.

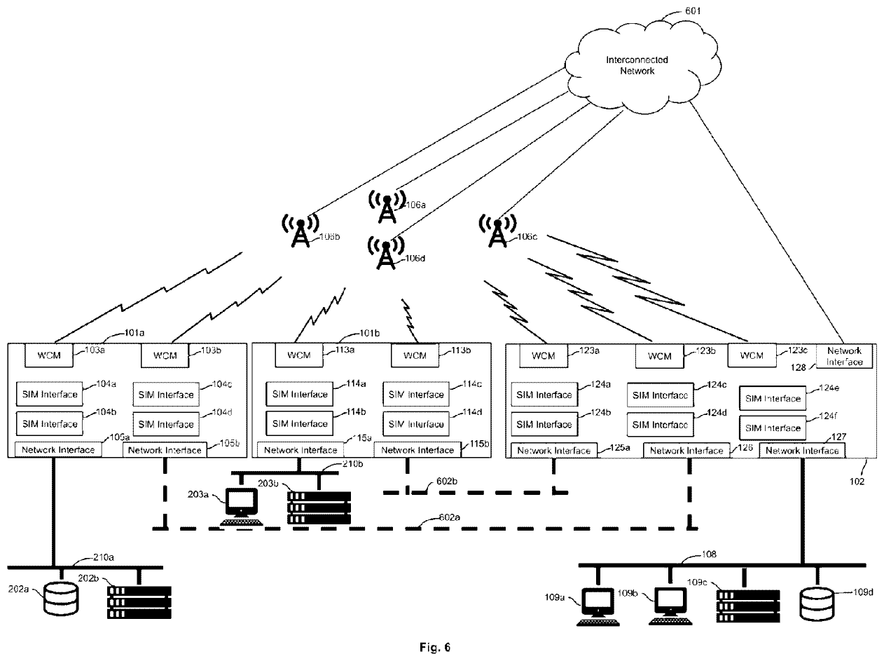

FIG. 6 illustrates a network environment according to various embodiments of the present invention. The network environment illustrated in FIG. 6 is similar to the network environment illustrated in FIG. 2. WCD 101a and WCD 101b are connected to WCD 102 through LANs 602a-b. However, LANs 602a-b are different from LANs 211a-b compared to FIG. 2. LANs 602a-b are established through the same or different interconnected networks instead of any direct wired or wireless connection. WCDs 101a, 101b, and 102 are located in different premises and communicate with each other using internet protocol (IP) packets through LANs 602a-b. The error rate and latency among WCDs 101a, 101b, and 102 are expected to be higher compared to using LANs 211a-b. WCDs 101a, 101b, and 102 are connected to interconnected network 601 via base stations 106a-d using WCMs 103a-b, 113a-b, and 123a-c respectively. WCD 102 is connected to interconnected network 601 using also network interface 128.

### BRIEF DESCRIPTION OF PRIOR ART

U.S. Pat. No. 11,277,736 disclosed methods and systems for a WCD to use one or more remote SIMs from one or more SIM banks. The WCD may be located at a different location from a SIM bank, and information of a SIM card at the SIM bank is sent to the WCD over an interconnected network. As the information of the SIM card is sent using a plurality of logical data connections, the complexity of the communication between the WCD and the SIM bank is complex.

U.S. Pat. No. 9,854,435 disclosed methods and systems for a WCD to use remote SIMs inserted at another device. The WCD and the other device are connected using an RS-435 or an Ethernet cable. However, one connection is required for a data port and another connection is required for a SIM port.

Further, for both U.S. Pat. Nos. 11,277,736 and 9,854,435, SIM cards at the WCD are unable to be used by other WCDs.

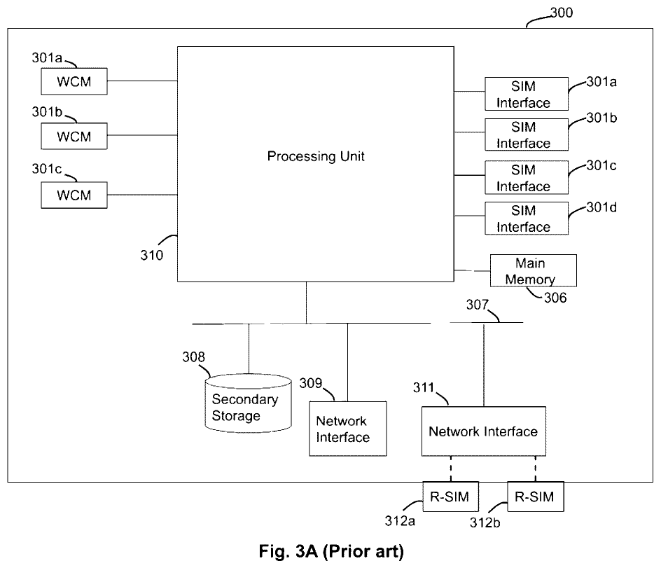

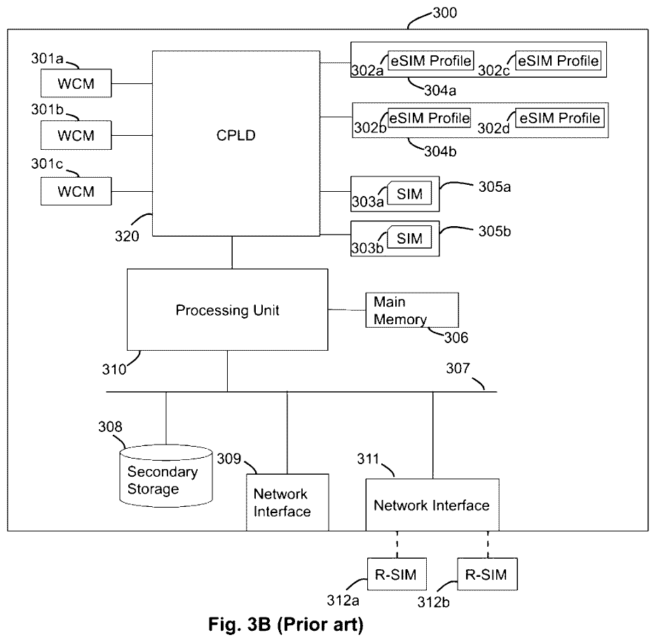

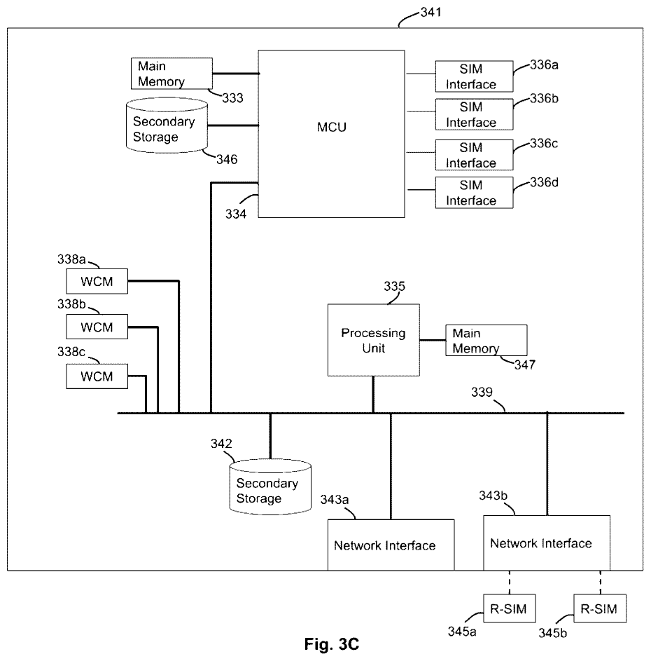

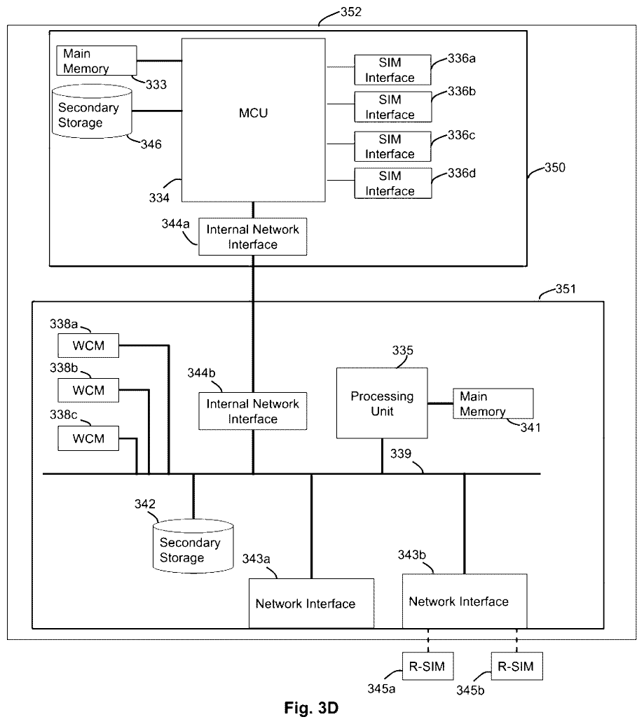

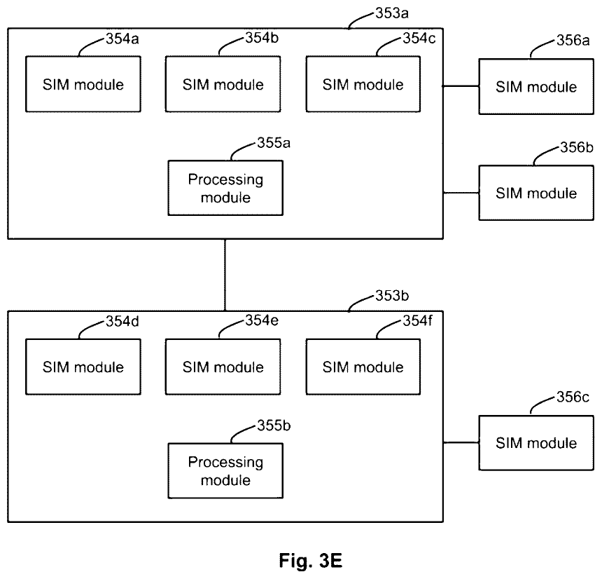

FIG. 3A and FIG. 3B are based on FIG. 1A and FIG. 1B of U.S. Pat. No. 11,277,736 respectively. U.S. Pat. No. 11,277,736 taught the schematic block diagrams of a WCD.

FIG. 3A was a schematic block diagram illustrating the hardware blocks of a WCD, WCD 300. WCD 300 comprises a plurality of SIM interfaces 301, which were capable of connecting to one or more UICCs and eSIM.

WCD 300 was configurable to connect one or more remote SIMs (R-SIMs) through the Internet. A remote SIM (R-SIM) is a SIM that is placed in a SIM bank. R-SIMs 312a and 312b might be placed in one or more SIM banks configurable to connect with WCD 300 through one or more data connections.

WCD 300 further comprises a plurality of WCMs, such as WCMs 301a-c. Each of the plurality of WCMs 301 is configurable to connect any one of the local SIMs (L-SIMs) or R-SIMs at a time. The Wireless communication modules, such as WCMs 301, may be connected to embedded/external antennas and perform wireless communication via the antennas. An example of WCM is Sierra Wireless EM7511.

Processing unit 310, executes program instructions and maybe a CPLD, a FPGA, a CPU, a microprocessor, MCU, DSP, any combination of those devices, or any other circuitry configurable to execute the program instructions. Processing unit 310 may be directly connected to SIM interfaces 305a-b, SIM interfaces 304a-b, WCMs 301a-c, and other hardware components, such as main memory 306, secondary storage 308, and system bus 307. SIM interfaces 304a-b is connected to an eSIM.

In FIG. 3B, CPLD 320 is connected to processing unit 310 in order to provide an adequate number of input/output pins. SIM interfaces 304a-b, SIM interfaces 305a-b and WCMs 301a-c are connected to the processing unit through CPLD 320 while the other hardware components, such as main memory 306 and system bus 307 were connected to the processing unit 310 directly, through another circuit, and/or through another CPLD.

Network interfaces 309 and 311, and secondary storage 308 were connected to processing unit 310 through system bus 307.

U.S. Pat. No. 10,412,658 disclosed methods and systems for a first WCD to use one or more other WCDs as slave gateways through one or more WAN network interfaces. However, it does not teach how a LAN network interface can be used to connect to a slave gateway. Further, it does not teach how a slave gateway could use a SIM card that is not housed inside the slave gateway. Further, it does not teach how slave gateways can be managed through the first WCD.

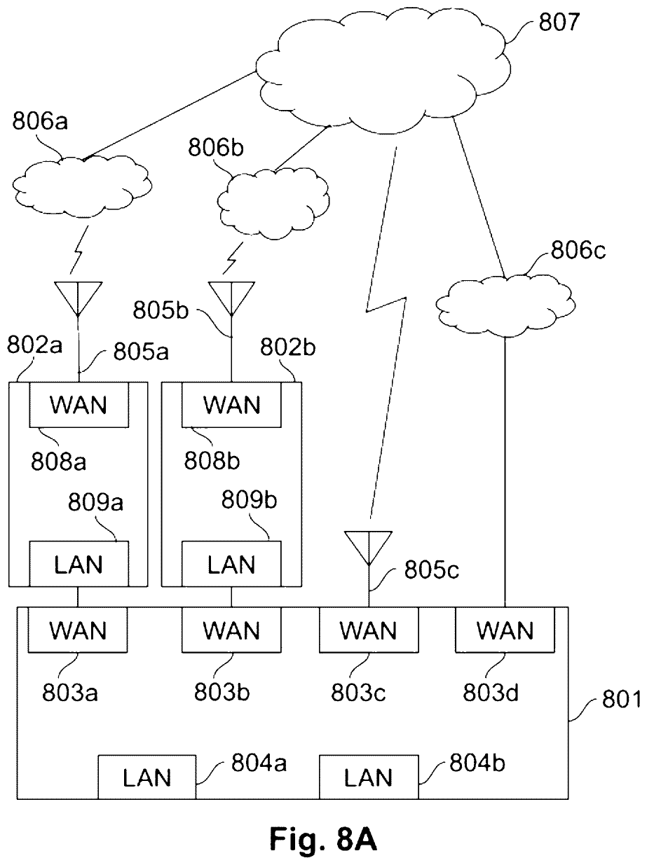

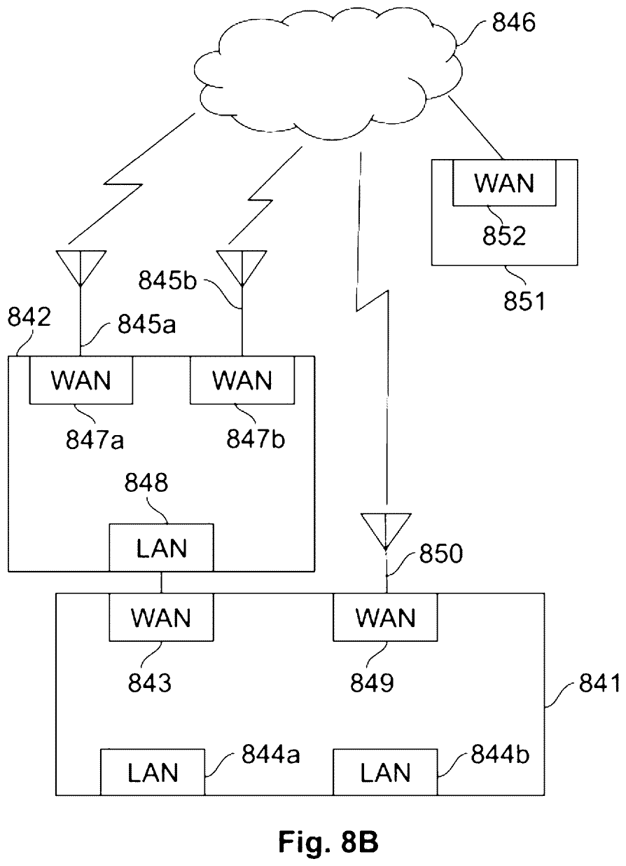

FIG. 8A and FIG. 8B are prior arts and are based on FIG. 1B and FIG. 1C of U.S. Pat. No. 10,412,658 respectively. U.S. Pat. No. 10,412,658 taught the schematic block diagrams of the first WCD and the slave gateway.

FIG. 8A illustrated a WCD, slave gateways, and how they are connected to each other. WCD 801 was connected to two slave gateways 802a-b via WAN interfaces 803a-b and LAN interfaces 809a-b. WCD 801 had WAN interfaces 803c and 803d for connecting to interconnected network 807 directly and indirectly via interconnected network 806 respectively. WAN interface 803c was a wireless WAN interface realized using a SIM card and to be used via antenna 805c. WAN interface 803d was a wired WAN interface and to be used via Ethernet cable to connect to interconnected network 807 via network 806c. WCD 801 was then connected to networks 806a-b through WAN interfaces 808a-b via antennas 805a-b of slave gateways 802a-b. WAN interfaces 808a-b were wireless WAN interfaces and realized using SIM cards. WCD 801 further had LAN interfaces 804a-b to receive data packets from hosts connected to WCD 801.

FIG. 8B illustrated a first WCD, a slave gateway, and how they are connected to each other. Compared to FIG. 8A, FIG. 8B illustrated one slave gateway, such as slave gateway 842. WCD 841 was connected to interconnected network 846 via two WAN interfaces 847a-b and antennas 845a-b of slave gateway 842. WCD 841 further had WAN interface 849 and antenna 850 to connect to interconnected network 846 directly and wirelessly. WAN interface 843 was used to connect WCD 841 with slave gateway 842 via LAN interface 848. WAN interfaces 850 and 847 were wireless WAN interfaces and realized using SIM cards. WCD 841 further had LANs 844a-b to receive data packets from hosts connected to WCD 841. Server 851 was connected to interconnected network 846 via WAN interface 852.

Further in FIGS. 8A and 8B, a WCD could use a SIM card housed by the WCD itself. For example, WCD 801 could use a SIM card that was housed by WCD 801 itself.

Compared to FIG. 8A and FIG. 8B, the present invention discloses that at least two WCDs could be connected to each other via a network interface, and therefore there is no limitation to configuring a network interface from one WCD to be a WAN interface and a network interface from another WCD to be a LAN interface. In the present invention, WCDs 101a-b are configurable to connect to each other via LAN interfaces. Both WCDs 101a-b are further configurable to use SIM cards from each other. For example, WCD 101a is configurable to use one or more SIM cards from WCD 101b, and vice versa. WCD 101a is also configurable to manage or configure WCD 101b, and vice versa. The same methods can be used for WCD 102 as the methods are applicable for WCD 101a-b in the present invention.

### Schematic Diagram

FIG. 3C illustrates a schematic block diagram of WCD 341, which could be used as WCDs 101a, 101b, and 102 according to various embodiments of the present invention. WCMs 338a-c are connected to processing unit 335 and MCU 334 through bus 339. Compared to the prior art, WCMs 338a-c do not have a direct wired connection to MCU 334. Therefore, the sending and retrieval of SIM information between any of WCMs 338a-c and any of SIM interfaces 336a-d, and SIM cards inserted into SIM interfaces 336a-d have to be controlled by processing unit 335. In one variant, the connection between MCU 334 and processing unit 335 may be directly connected, such that the connection is not shared with other components.

MCU 334 may be connected with main memory 333 and secondary storage 346.

When processing unit 335 assigns a SIM profile in a SIM card that is connected to one of SIM interfaces 336a-d to one of WCMs 338a-c, processing unit 335 will communicate with MCU 334 and one of WCMs 338a-c through bus 339. In one example, processing unit 335 has determined to assign the SIM card in the SIM card holder connecting to SIM interface 336b to WCM 338a. When WCM 338a needs SIM information, WCM 338a will send the request to the SIM card. The request will be intercepted by processing unit 335. Processing unit 335 then forwards the request to MCU 334 and identity of SIM interface 336b. The identity is used to inform MCU 334 that the request is intended for SIM interface 336b. Then MCU 334 forwards the request to SIM interface 336b. When the SIM card replies to the request, the reply is first received by MCU 334 through SIM interface 301b. Then MCU 334 sends the reply to processing unit 335 with the information that the reply is received from SIM interface 336b through bus 339. Processing unit 335 then sends the reply to WCM 338a.

In one variant, when processing unit 335 sends the request to MCU 334, the identity of WCM 338a may also be sent along with the request and the identity of SIM interface 336b. When MCU 334 sends the reply to processing unit 335, MCU 334 will send the identity of WCM 338a along with the reply. The identity of MCU 334 is used to assist processing unit 335 to determine the destination of the reply.

In one variant, when there is more than one profile in a SIM card, processing unit 335 and MCU 334 will include the profile identity when communicating.

In another example, processing unit 335 has determined to assign a SIM profile located at a remote device, for example, R-SIM 345a. When WCM 338a needs SIM information, the request will be intercepted by processing unit 335. Processing unit 335 then forwards the request to R-SIM 345a through network interface 343b with the identity of the SIM profile. The identity is used to inform R-SIM 345a that the request is intended for the SIM profile. When processing unit 335 has received the reply from R-SIM 345a, processing unit 335 will then send the reply to WCM 338a.

FIG. 3D illustrates various embodiments of the present invention of WCD 352, which could be used as WCDs 101a, 101b, and 102. Compared to FIG. 3C, SIM module 350 connects with processing module 351. SIM module 350 comprises main memory 333, secondary storage 346, MCU 334, SIM interfaces 336, and internal network interface 344a. Processing module 351 comprises main memory 347, secondary storage 342, processing unit 335, WCMs 338a-c, internal network interface 344b, and network interfaces 343. SIM module 350 and processing module 351 may be housed in one apparatus, such as network device 352. Network device 352, MCU 334, and processing unit 335 may be configured to consider each other as different and separate network devices and communicate using IP and Ethernet protocol. Therefore, information from and to SIM cards inserted into SIM interfaces 336a-d may be processed similarly to information from and to R-SIMs 345a-b.

In one variant, SIM module 350 may be a plurality of SIM modules that connect to processing module 351 through an internal network connected to internal network interface 344b. This modular approach allows the expansion of network device 352 and additional SIM module 350 may be added later, which may be housed inside or outside of network device 352. When the additional SIM module 350 is housed in one or more other apparatuses, internal network interface 344b may be used to connect to internal network interface 344a of the one or more other apparatuses using a LAN. The expansion of network device 352 will allow more SIM cards to be added and used. In one variant, instead of using network interfaces and a LAN, one or more SIM module 350 may be connected to processing module 351 through a bus, such as USB, or a serial communication interface like the Serial Peripheral Interface (SPI).

R-SIMs 345a-b, which are located in another network may be logically connected with one or more network interfaces 343.

SIM module 350 and processing modules 351 may belong to different regions of a printed circuit board (PCB), but also may belong to two or more PCBs. There is no limitation that one PCB must have only one SIM module 350 and one processing module 351. For example, WCD 102 may comprise a PCB, which may have three SIM modules and one processing module.

FIG. 3E illustrates a schematic block diagram of connections among WCD 353a, WCD 353b, and SIM module 356 based on the SIM module and the processing modules. WCD 353a and WCD 353b may be used as WCDs 101a, 101b, and 102. SIM modules 354a-c are housed inside of WCD 353a. SIM modules 354d-f are housed inside WCD 353b. SIM modules 356a-c are not housed in WCD 353a or WCD 353b and may be housed in different apparatuses. SIM modules 356a-b may be connected to WCD 353a through a LAN, a USB, a SPI, or any interface known to those skilled in the art. Similarly, SIM module 356c may be connected to WCD 353b through a LAN, a USB, a SPI, or any interface known to those skilled in the art. WCD 353a and WCD 353b are connected preferably using a LAN but may also be connected through other protocols or connection technologies as described in the description of FIG. 1.

Processing modules 355a and 355b may use any SIM interfaces in any of SIM modules 354a-f and 356a-c as long as the SIM interface is available and has a SIM card, which may also be an eSIM, associated with the SIM interface. The selection of SIM interfaces may be performed according to a policy.

There is no limitation on the number of WCDs. Therefore, more SIM cards and eSIMs may be added, selected, and used as the systems, illustrated in FIG. 1 and FIG. 2, expand.

### Grouping of SIM Cards

According to one of the embodiments of the present invention, the SIM cards are grouped into a plurality of SIM card groups based on a policy. In one variant, the SIM cards are grouped based on the location of SIM cards. For example, all the SIM cards housed at WCD 101a are grouped into a first SIM card group. All the SIM cards housed at WCD 101b are grouped into a second SIM card group. All the SIM cards housed at WCD 102 are grouped into a third SIM card group.

In another variant, the SIM cards are grouped based on the type of a SIM card. For example, all the SIM cards that are physical SIM cards are grouped in a first SIM card group. All the eSIM are grouped in a second SIM card group.

In another variant, the SIM cards are grouped based on a wireless carrier network of a SIM card. For example, if a SIM card is from Verizon, the SIM card will be grouped into a first SIM card group. If a SIM card is from Vodafone, the SIM card will be grouped into a second SIM card group. As the SIM cards are from different wireless carrier networks, there may be a plurality of SIM card groups based on the wireless carrier networks.

In another variant, the SIM cards are grouped based on the tariff price of a SIM card. The SIM cards that have higher tariff price are grouped into a first SIM card group. The SIM cards that have lower tariff price are grouped into a second SIM card group.

SIM selection module 451 is configurable to select one or more SIM card groups to be used based on a SIM selection policy.

### Sim Card Selection Policy

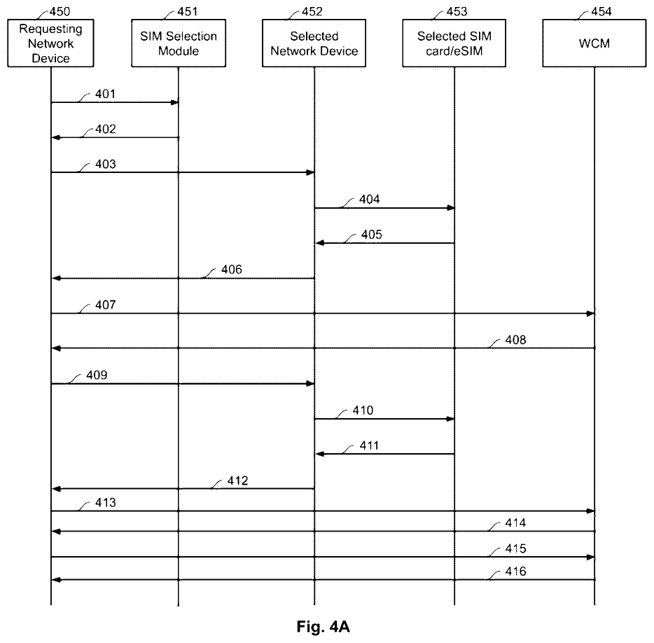

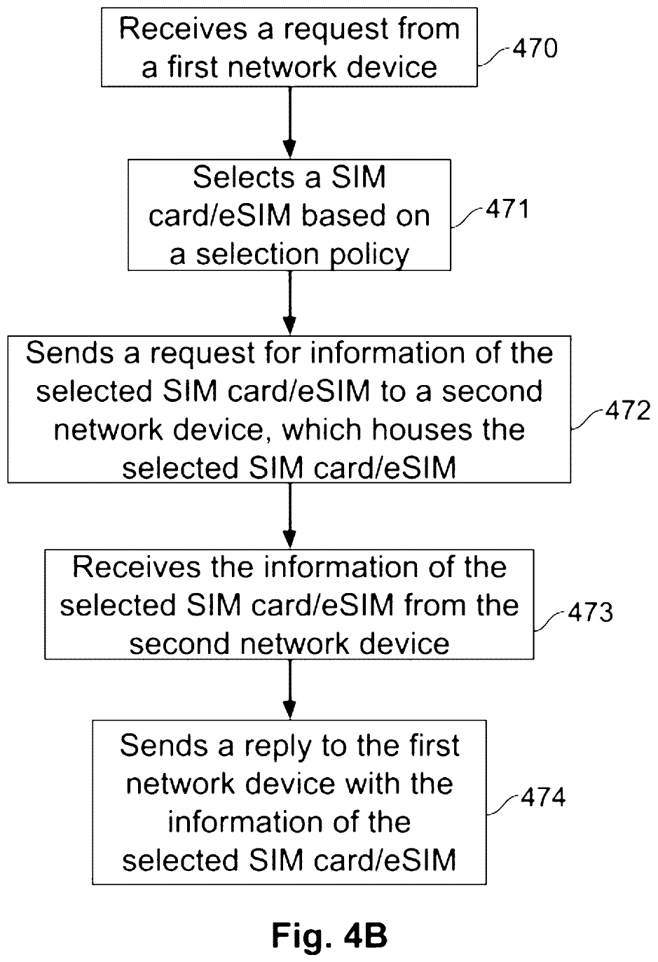

FIG. 4A is an event diagram that illustrates how messages are sent and received among requesting network device 450, SIM selection module 451, selected network device 452, selected SIM card/eSIM 453, and WCM 454 according to various embodiments of the present invention. The SIM selection module may be realized as a computer program performed at requesting network device 450, at selected network device 452, or at another device that is capable of communicating with request network device 450 and selected network device 452. In one variant, the SIM selection module 451 may be realized as a computing component installed into or connecting to the requesting network device or into the selected network device. For illustration purposes, network device 450 is WCD 102 and selected network device 452 is WCD 101a. Selected SIM card/eSIM 453 is placed in a SIM interface of WCD 101a, one of SIM interfaces 114. WCM 454 is one of WCMs 123.

Requesting network device 450 sends message 401 to SIM selection module 451 to enquire about the location and availability of a SIM card/eSIM. SIM selection module 451 may select a SIM card according to the information in request message 401, and may also apply additional selection criteria based on a selection policy. SIM selection module 451 sends message 402 to requesting network device 450 with information of selected network device 452 with information of selected SIM card/eSIM 453. Selected SIM card/eSIM 453 is placed in a SIM interface selected network device 452.

Requesting network device 450 sends message 403 to selected network device 452 to confirm the use of the selected SIM card/eSIM 453.

The processing unit of selected network device 452 sends message 404 to selected SIM card/eSIM 453 to confirm if selected SIM card/eSIM 453 is available and ready. Message 404 may be a reset message, or may be realized by toggling the reset pin of selected SIM card/eSIM 453 or powering up selected SIM card/eSIM 453. Selected SIM card/eSIM 453 then sends message 405 to the processing unit of selected network device 452. Message 405 may comprise identity information, such as Integrated Circuit Card Identification (ICCID) and an International Mobile Subscriber Identity (IMSI). Selected network device 452 then sends message 405 or the information in message 405 to the processing unit of selected network device 452 in message 406. In one variant, message 405 may not comprise identity information as the processing unit may retrieve the identity information from a secondary storage. Message 405 may comprise information to indicate that selected SIM card/eSIM 453 is ready for use.

After receiving the information of selected SIM card/eSIM 752 via message 406, the processing unit of requesting network device 450 then sends message 407 to WCM 454 to inform WCM 454 to initiate the SIM card authentication process. WCM 454 will then communicate with a wireless network carrier with the information of selected SIM card/eSIM 453 to establish a wireless communication channel with at least one wireless network of the wireless network carrier. The wireless network carrier may send an authentication request to WCM 454 to confirm the usage of selected SIM card/eSIM. WCM 454 then forwards the authentication request in message 408 to the processing unit of requesting network device 450.

Requesting network device 450 then forwards the authentication request in request message 409 to selected network device 452. The processing unit of selected network device 452 forwards the authentication request in message 410 to selected SIM card/eSIM 453. Selected SIM card/eSIM 453 then performs authentication confirmation against the authentication request. When an authentication confirmation result is ready, SIM card/eSIM 453 sends the authentication confirmation result in message 411 to the processing unit of selected network device 452. Selected network device 452 then forwards message 411 to requesting network device 450 in message 412. The processing unit of requesting network device 450 then forwards the authentication confirmation result in message 413 to WCM 454. WCM 454 then sends the authentication confirmation result to the wireless network carrier to complete the authentication process, and informs requesting network device 450 of the completion of the authentication process in message 414. The authentication may be considered as complete when an IP address is assigned to the WCM by the wireless network. After the authentication process, a wireless communication channel is then established between WCM 454 and the at least one wireless network of the wireless network carrier. Requesting network device 550 may start sending data to hosts, servers, and devices reachable through the at least one wireless network of the wireless network carrier by sending the data to WCM 454, which will send the data to the at least one wireless network, in message 415. When there is data received by WCM 454 destined to the host, WCM 454 will send the data to the processing unit of requesting network device 450 in message 416 for further processing.

As the processing unit of requesting network device 450 and WCM 454 are housed in the same apparatus, messages 407, 408, 413, 414, 415, and 416 may be sent through a bus, SPI, or internal network interfaces described in FIG. 3D and FIG. 3E.

In one variant, SIM selection module 451 is performed by the selected network device 452. Therefore messages 401 and 402 may not be required. Message 403 may be modified to request the availability of a SIM card/eSIM without any information of the SIM card/eSIM.

In one variant, WCM 454 may not be housed in requesting network device 450. For example, WCM 454 may be WCM 113b housed in WCD 101b while selected SIM card/eSIM 453 is placed in WCD 101a and requesting network device 450 is WCD 102. Requesting network device 450 will communicate with WCM 454 through a LAN and through the processing unit of WCD 101b. Messages 407, 408, 413, and 414 will be sent and received through the LAN.

In one variant, selected SIM card/eSIM 453 is a R-SIM located remotely and reachable through selected network device 452 through the interconnected networks. Messages 404, 405, 410 and 411 will then be sent and received through the interconnected networks.

FIG. 4B is a flowchart illustrating methods performed at a SIM selection module of the present disclosure. FIG. 4B should be viewed in conjunction with FIG. 4A for a better understanding of the embodiments.

In process 470, SIM selection module 451 receives request message 401 from a first network device. Herein, the first network device may be requesting network device 450.

In process 471, SIM selection module 451 selects a SIM card/eSIM, such as selected SIM card/eSIM 453, based on a selection policy.

The SIM selection policy may be based on the position of a selected SIM/eSIM placed in a selected network device, selected SIM/eSIM category, tariff price of a selected SIM/eSIM, network's performance history of a selected SIM/eSIM, services offered by the wireless carrier network of a selected SIM/eSIM, service quality of the wireless carrier network of a selected SIM/eSIM, administrator's preference, geolocation of a selected network device, billing cycle information and time. For example, when a selected SIM/eSIM is selected based on the geolocation of a selected network device, the selected SIM/eSIM should be selected from a local wireless carrier network corresponding to the current location or wireless carrier networks available at the selected network device. In this case, the selected SIM/eSIM is selected as it is from a corresponding wireless carrier which is a local wireless carrier network of the visited geographical area. Herein, the selected SIM/eSIM is selected SIM card/eSIM 453 and the selected network device is selected network device 452.

In process 472, SIM selection module 451 sends a request for information of selected SIM card/eSIM 453 to a second network device. Herein, the second network device is selected network device 452. Selected network device 452 may house selected SIM card/eSIM 453.

In process 473, SIM selection module 451 receives the information of selected SIM card/eSIM 453 from selected network device 452.

In process 474, SIM selection module 451 sends a reply with the information of selected SIM card/eSIM 453 to requesting network device 450.

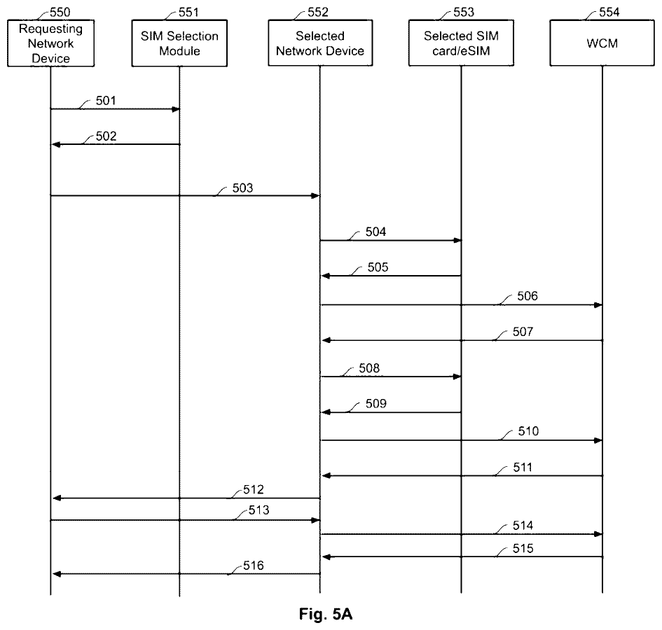

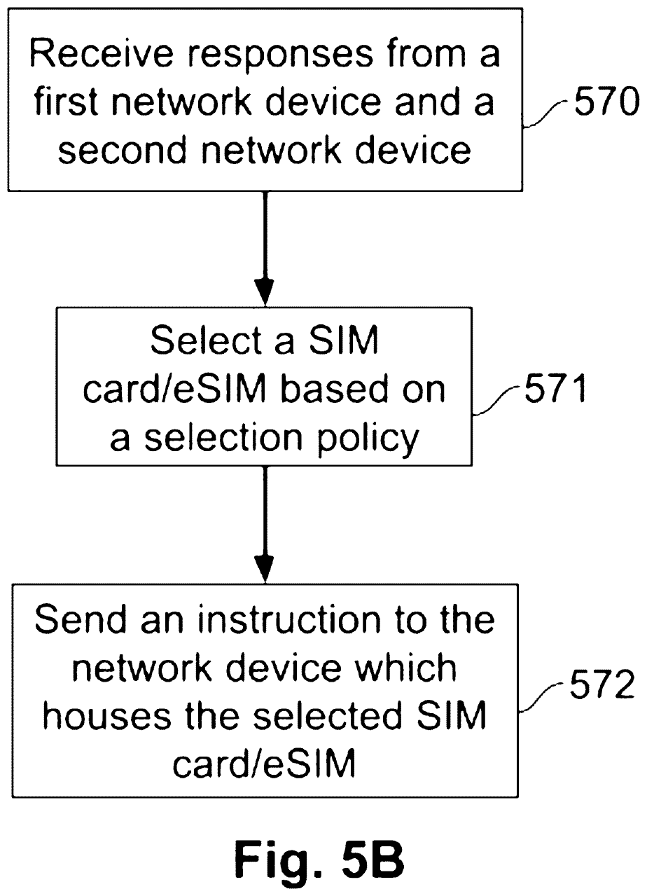

FIG. 5A is a diagram that illustrates how messages are sent and received among requesting network device 550, SIM selection module 551, selected network device 552, selected SIM card/eSIM 553, and WCM 554 according to various embodiments of the present invention. Compared to the events illustrated in FIG. 4A, WCM 554 is a WCM of selected network device 552, not a WCM of requesting network device 550. For illustration purposes, requesting network device 550 is WCD 102 and selected network device 552 is WCD 101a. Selected SIM card/eSIM 553 is placed in a SIM interface of WCD 101a, one of SIM interfaces 104. WCM 554 is one of WCMs 103. Therefore, selected SIM card/eSIM 553 and WCD 554 are capable of communicating with the processing unit of selected network device 442 internally inside selected network device 442.

Requesting network device 550 sends message 501 to SIM selection module 551 to enquire about the location and availability of a SIM card/eSIM. SIM selection module 551 sends message 502 to requesting network device 450 with information of selected network device 552 with information of selected SIM card/eSIM 553.

Requesting network device 550 sends message 503 to selected network device 552 to instruct selected network device to use a WCM of selected network device 552 with selected SIM card/eSIM 553.

The processing unit of selected network device 552 sends message 504, which has the same purpose as message 404, to selected SIM card/eSIM 553 to confirm if selected SIM card/eSIM 553 is available and ready. Selected SIM card/eSIM 553 then sends message 505, which has the same purpose as message 405, to the processing unit of selected network device 552. The processing unit of selected network device 552 then sends message 506 to WCM 554 to inform WCM 554 to initiate the SIM card authentication process. WCM 554 will then communicate with a wireless network carrier with the information of selected SIM card/eSIM 553 to establish a wireless communication channel with the at least one wireless network of the wireless network carrier. The wireless network carrier may send an authentication request to WCM 554 to confirm the usage of selected SIM card/eSIM. WCM 554 then forwards the authentication request in message 507 to the processing unit of selected network device 552. The processing unit of selected network device 552 forwards the authentication request in message 508 to selected SIM card/eSIM 553 to perform authentication confirmation against the authentication request. When an authentication confirmation result is ready, SIM card/eSIM 553 sends the authentication confirmation result in message 509 to the processing unit of selected network device 552. The processing unit of selected network device 552 then forwards the authentication confirmation result in message 510 to WCM 554. WCM 554 then sends the authentication confirmation result to the wireless network carrier to complete the authentication process, and informs the processing unit of selected network device 552 of the completion of the authentication process in message 511. Selected network device 552 then informs requesting network device 550 the completion of the authentication process in message 512. After the authentication process, a wireless communication channel is then established between WCM 554 and the wireless network of the wireless network carrier.

Requesting network device 550 may start sending data to hosts, servers, and devices reachable through the wireless network of the wireless network carrier by embedding the data in message 513 to selected network device 552. The data may have originated from a host connected to requesting network device 550. The processing unit of selected network device 552 then sends the data to WCM 554, which will send the data to the wireless network, in message 514. When there is data received by WCM 554 destined to the host, WCM 554 will send the data to the processing unit of selected network device 552 in message 515. Then selected network device 552 sends the data to requesting network device 550 in message 516 for further processing.

In one example, requesting network device 550 is WCD 101a and there is a plurality of selected network devices 552, such as WCD 101b and WCD 102. There are also a plurality of selected SIM cards/eSIM 553 and a plurality of WCM 554. The plurality of selected SIM cards/eSIM 553 may be placed in SIM interfaces of WCD 101b and WCD 102. All the WCMs of the plurality of WCM 554 are housed in WCD 101a, such as WCMs 103a and 103b. In order to establish wireless communication channels, the events illustrated in FIG. 5A may be performed for each of the WCMs. WCD 101a may then be capable of sending and receiving data through the plurality of wireless communication channels. In a system that comprises a plurality of WCDs, such as the one illustrated in FIG. 1 and FIG. 2, the system is then capable of providing data connectivity through a plurality of wireless communication channels for its hosts, devices, and servers to communicate with remote hosts, devices, and servers.

In one variant, selected SIM card/eSIM 553 is a R-SIM located remotely. Selected network device 552 may then communicate with selected SIM card/eSIM 553 through the interconnect networks. Messages 504, 505, 508 and 509 will then be sent and received through the interconnected networks.

FIG. 5B is a flowchart illustrating methods performed at a SIM selection module of the present disclosure. FIG. 5B should be viewed in conjunction with FIG. 5A for a better understanding of the embodiments.

In process 570, requesting network device 550 receives reply messages 502 and 504 from a first network device and a second network device. Herein, the first network device may be responding network device 551 and the second network device may be responding network device 552.

In process 571, requesting network device 550 selects a SIM card/eSIM, such as selected SIM card/eSIM 553, based on a selection policy. The SIM selection policy may be identical to the SIM selection policy described in FIG. 4A.

In process 572, requesting network device 550 sends an instruction to responding network device 552 that houses selected SIM card/eSIM 553.

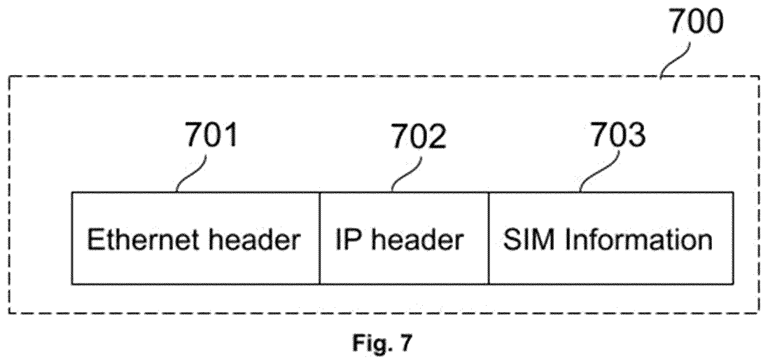

FIG. 7 illustrates the structure of a message sent or received among a requesting network device, a SIM selection module, a selected network device, a selected SIM card/eSIM, and a WCM of the requesting network device. FIG. 7 should be viewed in conjunction with FIG. 4A and FIG. 4B.

Ethernet frame 700 comprises Ethernet header 701, IP header 702, and SIM card information 703. Those who are skilled in the art would recognize that the IP packet has the SIM information in the IP packet payload, and the Ethernet frame has the IP packet in the Ethernet frame payload.

When sending data, such as SIM card information 703, requesting network device 450 and selected network device 452 are capable of encapsulating the data into the payload of one or more IP packets and then encapsulating one or more IP packets into the payload of one or more ethernet frames 700.

When receiving one or more ethernet frames 700, requesting network device 450 and selected network device 452 are capable of decapsulating the one or more ethernet frames 700 to retrieve one or more IP packets from the payload of one or more ethernet frames 700. Requesting network device 450 and selected network device 452 then decapsulate one or more IP packets to retrieve the data from the payload one or more IP packets.

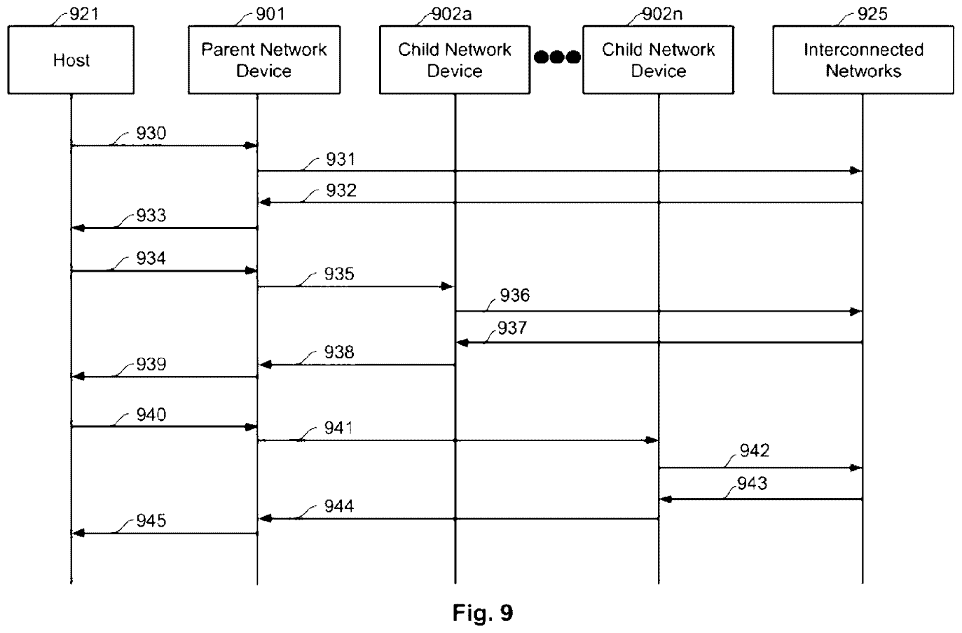

FIG. 9 illustrates an event sequence figure according to various embodiments of the present invention and should be viewed in conjunction with FIG. 1 or FIG. 2. Host 921, which may be any of hosts 109a-d in FIG. 1 and FIG. 2, connected to parent network device 901 through a LAN. Parent network device 901 may connect to child network devices 902 through the same LAN or other LANs or virtual LANs. For illustration purposes only, parent network device 901 is WCD 102, child network device 902a is WCD 101a, and child network device 902n is WCD 101b. Parent network device 901 may send data received from host 921 to another host reachable through interconnected networks 925 using any of WCMs in parent network device 901 and child network devices 902 according to one or more outbound policies.

In step 930, host 921 sends data packets to parent network device 901, the processing unit of parent network device 901 then forwards the data packets to interconnected networks 925 in step 931 using one of its WCMs, such as any of WCMs 123. When parent network device 901 receives data packets from interconnected networks 925 in step 932 through the WCM, parent network device 901 then forwards the data packets to host 921 in step 933.

In step 934, host 921 sends data packets to parent network device 901, the processing unit of parent network device 901 then forwards the data packets first to child network device 902a in step 935. Then the processing unit of child network device 902a forwards the data packets to interconnected networks 925 in step 936 using one of its WCMs, such as WCMs 103. When child network device 902a receives data packets from interconnected networks 925 in step 937 through the WCM, child network device 902a then forwards the data packets to parent network device 901 in step 938. Then parent network device 901 forwards the data packets to host 921 in step 939.

In step 940, host 921 sends data packets to parent network device 901, the processing unit of parent network device 901 then forwards the data packets first to child network device 902b in step 941. Then the processing unit of child network device 902b forwards the data packets to interconnected networks 925 in step 942 using one of its WCMs, such as WCMs 113. When child network device 902b receives data packets from interconnected networks 925 in step 943 through the WCM, child network device 902b then forwards the data packets to parent network device 901 in step 944. Then parent network device 901 forwards the data packets to host 921 in step 945.

The use of the parent network device and child network devices allows a network administrator to add more WCDs and WCMs when required. In one variant, a network administrator may further add more SIM cards for selection by connecting SIM module described in FIG. 3E to the parent network device and/or the child network devices. The processing unit of the parent network device may first select a SIM card from the SIM 26 module, then associate the SIM card with a WCM, and then use the WCM to send and receive data packets.

### User Interface

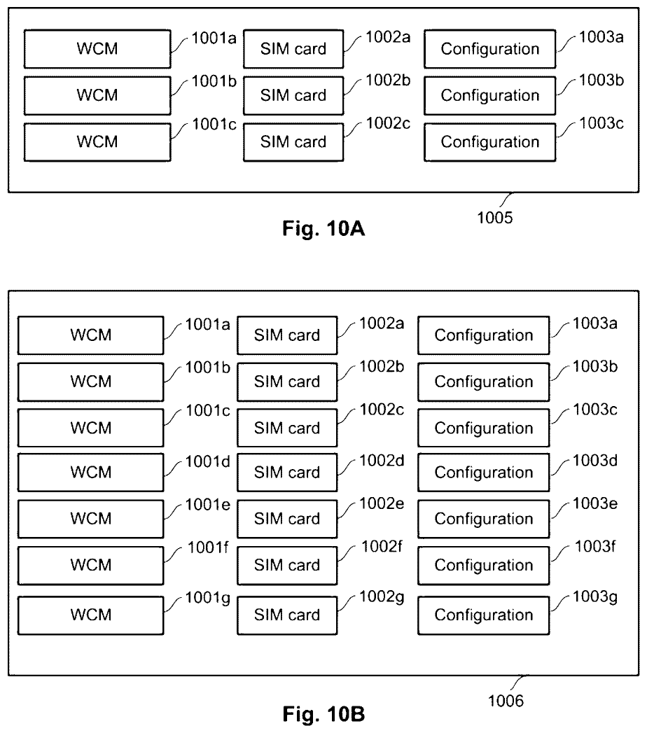

FIG. 10A illustrates a user interface according to various embodiments of the present invention for configuring, presenting and displaying information of WCMs and SIM cards of a WCD when the WCD is not connected with another WCD. The user interface may be realized, based on information provided by the processing unit according to programming instructions, on a webpage, an LCD screen, an OLED screen, or a control panel. The user interface may be sent through using networking technologies, a serial console, or a bus connection.

In one example, user interface 1005 is the user interface created by the processing unit of WCD 102. When WCD 102 is not managing WCD 101a or the parent of WCD 101a, user interface 1005 of WCD 102 has field 1001 for identifying WCMs of WCD 102, field 1002 for identifying SIM cards being used, and fields 1003 to allow configurations of the WCM and/or SIM card identified. The three SIM cards identified housed in WCD 102 may be the SIM cards housed inside WCD 102, SIM cards housed in WCD 101a, SIM cards housed in WCD 101b, or remote SIMs located at one or more SIM banks accessed through the interconnected networks. IP address, proxy server, priority levels, usage quota, usage time, usage policy, access point name (APN), virtual private network (VPN) configuration, SIM card selection policy, and other information that is required to configure the corresponding WCM and SIM card. There is no limitation that field 1003a must be one field. Fields 1003 may comprise a plurality of fields or pages of fields.

Alternatively, fields 1002 may be used to identify SIM interfaces, such as SIM interfaces 104, 114, and 124 instead of SIM cards. The SIM interfaces may have been associated with a SIM card or not.

In one example, when there is no SIM card selected for the WCM identified in field 1001b, field 1002b may be empty. When a SIM card is selected later, field 1002b will then be updated with the identity and information of the selected SIM card.

FIG. 10B illustrates a user interface according to various embodiments of the present invention for configuring, presenting and displaying information of WCMs and SIM cards of a WCD when the WCD is connected with one or more other WCDs and the 27 WCD is performing as a parent to the one or more other WCDs. A network administrator is then able to configure one or more other WCDs through the WCD.

For example, WCD 102, which is a parent network device as described in FIG. 9, is used to manage and configure WCDs 101a-b, which are child network devices as described in FIG. 9. Compared to FIG. 10A, user interface 1006 includes additional fields 1001d-g to identify WCMs of WCDs 101a-b, fields 1002d-g to identify SIM cards associated with WCMs of WCDs 101a-b and fields 1003d-g to configure the identified WCMSs and the SIM cards of WCDs 101a-b.

The processing unit of WCD 102 may communicate with the processing unit of WCDs 101 a-b to establish the relationship that WCD 102 is performing as the parent while WCDs 101a-b is performing as the child. The relationship is based on the configurations of WCDs 101a, 101b, and 102 inputted by the network administrator. There is no limitation that WCD 102 must be the parent. The network administrator, for example, may configure WCD 101a to be the parent while WCD 101b and WCD 102 to be the children.

User interface 1006 allows the network administrator to view the configurations of, manage and configure WCD 101a, WCD 101b and WCD 102 in one unified user interface.

In one example, the network administrator may input configuration parameters in fields 1003 for establishing an aggregated end-to-end connection. The network administrator may select WCMs, SIM interfaces, and/or SIM cards to establish the plurality of end-to-end connections that form the aggregated end-to-end connection. In one variant, the network administrator may configure a policy for establishing the aggregated end-to-end connection. The policy may include criteria to select a plurality of WCMs, a plurality of SIM interfaces, and/or a plurality of SIM cards that are used for establishing the aggregated end-to-end connection. The policy may also include, passwords, security certificates, encryption mechanism, communication protocol, preference of SIM cards, usage quota, IP addresses of the network device or server at the other end of the aggregated end-to-end connection, and other information to facilitate the use and establishment of the aggregated end-to-end connection.

There is no limitation that user interfaces 1005 and 1006 only have fields 1001, 1002, and 1003. Other fields, information, messages, alerts, inputs, and outputs may also be included in user interfaces 1005 and 1006. For example, an icon may be displayed next to field 1002g when the data usage of the SIM card identified in field 1002 is about to reach a usage quota.

In one variant, when a WCM is configured to use a R-SIM, the corresponding field 1002 may show the information and identity of the R-SIM. As the R-SIM is located remotely, the corresponding configuration may comprise information of the device that has the R-SIM. The corresponding configure may include host name or IP address of the device, password, and location or identity of the R-SIM.

In one variant, a remote server generates user interfaces 1006 based on information provided by the WCD 101a, WCD 101b, and WCD 102. A network administrator may then sign in with the remote server to view information and configure WCD 101a, WCD 101b, and WCD 102. The remote server may communicate with WCD 101a, WCD 101b, and WCD 102 to retrieve information and to send the configurations.

In a system that comprises a parent network device and a plurality of children network devices, such as the one illustrated in FIG. 1 and FIG. 2, the system may be managed through the parent network device and is capable of providing data connectivity through a plurality of wireless communication channels for its hosts, devices and servers to communicate with remote hosts, devices, and servers.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components, and the methods described may include more, fewer, or other steps. Additionally, steps may be performed in any suitable order. As used in this document, “each” refers to each member of a set or each member of a subset of a set.

1. A method of using a universal integrated circuit card (UICC) of a second network device at a first network device, comprising:
(a) sending a UICC selection request to a UICC selection module;
(b) receiving a UICC selection reply from the UICC selection module;
(c) sending a first UICC information request to the second network device;
(d) receiving a first UICC information from the second network device; wherein the first UICC information comprises UICC information received from a first UICC;
(e) using a first wireless communication module of the first network device to establish a first wireless communication channel with the first UICC information;
wherein the first network device and the second network device are connected through a cable or through a local area network;
wherein the second network device is comprised of a plurality of UICC interfaces and a plurality of wireless communications modules; and
wherein the first network device comprises at least one wireless communication module.

2. The method of claim 1, wherein the second network device is comprised of at least two processing units and at least two internal network interfaces; and
wherein the at least two processing units communicate using Internet Protocol (IP) packets through the at least two internal network interfaces.

3. The method of claim 2, wherein the IP packets are encapsulated in Ethernet frames.

4. The method of claim 1, wherein the first network device and the second network device are located in the same premises.

5. The method of claim 1, wherein the first network device and the second network device are connected using a local wireless area network or using near-field communication technology; and
wherein the first network device is managed through the second network device.

6. The method of claim 1, wherein the first UICC is selected from a group of UICCs; and wherein the second network device is capable of housing a plurality of UICCs and a plurality of eUICCs.

7. The method of claim 1, further comprising:
(f) sending a second UICC information request to a third network device;
(g) receiving a second UICC information from the third network device; wherein the second UICC information comprises UICC information received from a second UICC;
(h) using a second wireless modem of the first network device to establish a second wireless communication channel with the second UICC information;
wherein the third network device is located remotely.

8. The method of claim 7, further comprising:
when a third UICC of the group of UICCs is located at the third network device, communicating with the third network device to use the third UICC.

9. A method of communicating wirelessly at a first network device and a second network device using a plurality of UICCs, comprising:
(a) selecting a first UICC and a second UICC from the plurality of UICCs;
(b) at the first network device, when the first UICC is located at the second network device, communicating with the second network device to use the first UICC;
(c) at the first network device, when the first UICC is located at the first network device, using the first UICC locally;
(d) at the first network device, establishing a first wireless communication channel using the first UICC;
(e) at the second network device, when the second UICC is located at the second network device, using the second UICC locally;
(f) at the second network device, when the second UICC is located at the first network device, communicating with the first network device to use the second UICC;
(e) at the second network device, establishing a second wireless communication channel using the second UICC;
(g) communicating wirelessly with at least one wireless network through the first wireless communication channel and the second wireless communication channel;
wherein the first network device and the second network device are connected through a cable or through a local area network;
wherein the first network device is comprised of a first plurality of UICC interfaces and a first plurality of wireless communication modules;
wherein the second network device is comprised of a second plurality of UICC interfaces and a second plurality of wireless communications modules; and
wherein the plurality of UICCs are placed in the first plurality of UICC interfaces and the second plurality of UICC interfaces.

10. The method of claim 9, wherein the second network device is capable of being managed through the first network device.

11. The method of claim 9, further comprising: establishing an aggregated end-to-end connection through the first wireless communication channel and the second wireless communication channel.

12. A system for using a universal integrated circuit (UICC) card of a second network device at a first network device, comprising:
the first network device; and
the second network device;
wherein the first network device comprises:
at least one processing unit;
at least one main memory; and
at least one non-transitory computer-readable storage medium for storing program instructions executable by the at least one processing unit for:
(a) sending a UICC selection request to a UICC selection module;
(b) receiving a UICC selection reply from the UICC selection module;
(c) sending a first UICC information request to a second network device;
(d) receiving a first UICC information from the second network device; wherein the first UICC information includes UICC information received from a first UICC;
(e) using a first wireless communication module of the first network device with the first UICC information;
wherein the first network device and the second network device are connected through a cable or through a local area network;
wherein the second network device is comprised of a plurality of UICC interfaces and a plurality of wireless communications modules; and
wherein the first network device is comprised of at least one wireless communication module.

13. The system of claim 12, wherein the second network device is comprised of at least two processing units and at least two internal network interfaces; and
wherein the two processing units communicate using Internet Protocol (IP) packets through the at least two internal network interfaces.

14. The system of claim 13, wherein the IP packets are encapsulated in Ethernet frames.

15. The system of claim 12, wherein the first network device and the second network device are located in the same premises.

16. The system of claim 12, wherein the first network device and the second network device are connected using a local wireless area network or using near-field communication technology; and
wherein the first network device is managed through the second network device.

17. The system of claim 12, wherein the first UICC is selected from a group of UICCs; and
wherein the second network device is capable of housing a plurality of UICCs and a plurality of eUICCs.

18. The system of claim 12, wherein the at least one non-transitory computer-readable storage medium for further storing program instructions executable by the at least one processing unit for:
(f) sending a second UICC information request to a third network device;
(g) receiving a second UICC information from the third network device; wherein the second UICC information includes UICC information received from a second UICC;
(h) using a second wireless communication module of the first network device to establish a second communication channel with the second UICC information;
wherein the third network device is located remotely.

19. The system of claim 18, wherein the at least one non-transitory computer-readable storage medium for further storing program instructions executable by the at least one processing unit for:
when a third UICC of the group of UICCs is located at the third network device, communicating with the third network device to use the third UICC.

20. The system of claim 12, wherein the first network device is capable of being managed through the second network device.
